(19) United States
(12) Patent Application Publication
(10) Pub. No.: US 2025/0391890 A1
(43) Pub. Date: Dec. 25, 2025

(54) BIPOLAR PLATE, BIPOLAR PLATE ASSEMBLY, AND FUEL CELL UNIT

(71) Applicant: EKPO Fuel Cell Technologies GmbH, Dettingen (DE)

(72) Inventors: Michael SCHAICH, Dettingen (DE); Joachim SCHERER, Dettingen (DE); Leander HESS, Dettingen (DE); Simon GRUENENWALD, Dettingen (DE); Christian WEESE, Dettingen (DE); Dominic SCHIETINGER, Dettingen (DE)

(73) Assignee: EKPO Fuel Cell Technologies GmbH, Dettingen (DE)

(21) Appl. No.: 19/308,197

(22) Filed: Aug. 23, 2025

Related U.S. Application Data
(63) Continuation of application No. PCT/EP2024/054845, filed on Feb. 26, 2024.

(30) Foreign Application Priority Data
Mar. 3, 2023 (DE) 10 2023 105 283.7

(51) Int. Cl. H01M 8/0265; H01M 8/0263

(52) U.S. Cl. CPC H01M 8/0265; H01M 8/0263

(57) ABSTRACT

In order to provide a bipolar plate for a fuel cell unit, by which an optimized supply and/or evacuation of a fluid medium to and/or from a membrane-electrode unit is achieved, it is proposed that, on a bipolar plate body, multiple flow channels are configured, which form at least one flow field for a fluid medium, a bypass channel is formed between an edge flange and a delimiting device, and at least one passage is configured, whereby a fluidic connection is provided between the flow field and the bypass channel, wherein at least one interference element is provided in the bypass channel, which forms an overflow region for the fluid medium.

### RELATED APPLICATION

This application is a continuation of international application No. PCT/EP2024/054845 filed on Feb. 26, 2024, and claims the benefit of German application No. 10 2023 105 283.7 filed on Mar. 3, 2023, which are incorporated herein by reference in their entirety and for all purposes.

### FIELD OF DISCLOSURE

The present invention relates to a bipolar plate and to a bipolar plate assembly for a fuel cell unit, and to a fuel cell unit.

### BACKGROUND

A core component of a fuel cell is formed by the membrane-electrode units, which, on the cathode side and anode side, are mutually separated by bipolar plates. Bipolar plates have a channel structure which forms a flow field and through which reaction media are uniformly supplied to the membrane-electrode units and reaction products are evacuated.

### SUMMARY OF THE INVENTION

The object of the present invention is to provide a bipolar plate and a bipolar plate assembly, by means of which an optimized supply and/or evacuation of a fluid medium to and/or from a membrane-electrode unit is achieved. In addition, the object of the invention is to provide a fuel cell unit which has an optimum performance potential.

According to the invention, this object is fulfilled by a bipolar plate for a fuel cell unit, comprising at least one bipolar plate body on which multiple flow channels are configured, which form at least one flow field for a fluid medium, at least one edge flange is configured, which delimits the flow field at least in sections, at least one delimiting device is provided, which is arranged in relation to the edge flange such that a bypass channel is formed between the edge flange and the delimiting device, and at least one passage is provided, by means of which a fluidic connection is provided between the flow field and the bypass channel, wherein at least one interference element is provided in the bypass channel, which forms an overflow region for the fluid medium.

The bipolar plate can preferably be configured from one layer of the bipolar plate body or from multiple layers of the bipolar plate body.

In particular, the at least one bipolar plate body can be configured from metal, graphite, a graphite-polymer composition or from ceramic.

The at least one bipolar plate body can be provided with a coating, for example platinum or palladium.

In particular, the flow channels which form the flow field for the fluid medium can be configured from the at least one bipolar plate body, preferably can be molded therefrom, molded thereon or incorporated therein.

The at least one edge flange is configured to delimit the flow field at an outer side of the bipolar plate at least in sections.

The at least one edge flange preferably delimits an outermost flow channel of the flow field at an edge region of the bipolar plate or at an outer side of the bipolar plate.

In particular, the at least one edge flange can be configured from the at least one bipolar plate body, preferably can be molded therefrom, molded thereon or incorporated therein.

In particular, the at least one edge flange is configured integrally from the at least one bipolar plate body.

The at least one delimiting device forms a delimitation, in particular a seal, of the flow field vis-à-vis the outer side of the bipolar plate.

Preferably, the at least one delimiting device is provided spaced apart from the at least one edge flange on the bipolar plate body vis-à-vis the edge region of the bipolar plate or vis-à-vis the outer side of the bipolar plate.

Along its direction of extension, the at least one delimiting device can preferably be configured with an undulating profile at least in regions.

Along its direction of extension, the at least one delimiting device can also be configured with a straight-line profile.

A flow region or flow channel, which forms the bypass channel, is configured between the at least one delimiting device and the at least one edge flange.

The at least one delimiting device can preferably be configured from the at least one bipolar plate body, preferably can be molded therefrom, molded thereon or incorporated therein.

In particular, the at least one delimiting device is configured integrally from the at least one bipolar plate body.

The at least one delimiting device can preferably be configured in the form of a bead which is configured by the bipolar plate body.

Alternatively, the at least one delimiting device can also be provided in the form of a sealing element.

A sealing element of this type can preferably be configured from an elastomer material.

The sealing element can preferably be fitted to the bipolar plate body, applied thereto, molded thereon, adhesively bonded thereto, welded thereto, or the like.

The bypass channel is preferably a flow channel which bypasses the flow field at least in regions.

By means of the passage, the bypass channel is fluidically connected to the flow field.

The passage can preferably be an at least partial interruption of the edge flange.

In particular, the passage can be a structural interruption of the edge flange, also referred to as a weld gate, by means of which the fluidic connection between the flow field and the bypass channel is formed.

Through the at least one passage, a partial volume flow of the fluid medium which flows through the flow field can flow into the bypass channel and bypass or flow around the flow field at least in some regions.

This partial volume flow of the fluid medium, i.e. the fluid medium flowing through the bypass channel, is thus not available, or is only partially available, for the reaction on the membrane-electrode unit, which can result in a loss of efficiency of the fuel cell.

The at least one interference element, which is provided in the bypass channel and comprises the overflow region for the fluid medium, can form a flow resistance for the fluid medium flowing through the bypass channel.

By means of the interference element which comprises the overflow region, an interference in the flow of the fluid medium flowing in the bypass channel can preferably be formed.

In the overflow region, it is provided that at least a partial volume flow of the fluid medium flowing in the bypass channel flows over the interference element in the direction of a longitudinal extension of the bypass channel, and thus overflows said interference element.

In particular, the overflow region is formed by a clearance between the interference element and a further bipolar plate body which is opposite the interference element and also delimits the bypass channel.

In particular, the at least one interference element can be configured such that the flow resistance for the fluid medium flowing in the bypass channel is formed by an overflow and a flow of the fluid medium around the interference element.

Preferably, on the grounds of the overflow region of the at least one interference element, an increased flow resistance, and thus an increased pressure loss for the fluid medium flowing through the bypass channel can be provided and as a result a reduced partial volume flow of the fluid medium can flow through the bypass channel and a greater volume flow can flow through the flow field of the bipolar plate.

A preferred configuration of the bipolar plate can provide that the at least one interference element is formed by the bipolar plate body and/or is arranged as a separate element in the bypass channel.

The at least one interference element can preferably be molded from the bipolar plate body, i.e. can be integrally formed therefrom, molded thereon or incorporated therein.

If the at least one delimiting device is configured as a sealing element, it can also be provided that the at least one interference element is molded from the sealing element or is molded onto the sealing element.

In a further development of the bipolar plate, the at least one interference element can be integrally configured with the edge flange and/or the delimiting device and can extend from the edge flange and/or the delimiting device into the bypass channel.

In the case of the bipolar plate, it can preferably be provided that the at least one interference element extends from the edge flange and/or from the delimiting device in a web-shaped or tongue-shaped manner in the bypass channel.

The at least one interference element with the overflow region preferably projects into the bypass channel in a web-shaped or tongue-shaped manner.

The at least one interference element with the overflow region preferably extends essentially at right angles to the edge flange and/or to the delimiting device or at an inclined angle into the bypass channel.

In particular, it is provided that the overflow region is essentially arranged at right angles to a primary direction of extension of the bypass channel.

It can also be provided that the at least one interference element with the overflow region extends over a full width of the bypass channel. It can thus be achieved that the entire volume flow of the fluid medium overflows the overflow region of the interference element.

In an advantageous further development of the bipolar plate, a cross-sectional height of the bypass channel in the overflow region of the interference element can be configured to be smaller than a cross-sectional height of the bypass channel in a primary flow region.

A height of the at least one interference element in the overflow region can preferably be configured to be lower than a height of the edge flange and/or of the delimiting device.

In particular, the overflow region of the at least one interference element can be configured such that, in relation to a base level of the bipolar plate body, a height of the interference element is configured to be lower than a height of the edge flange and/or of the delimiting device.

A further preferred configuration of the bipolar plate can provide that a flow cross section of the bypass channel in the overflow region is configured to be smaller than a flow cross section of the bypass channel in a primary flow region.

The primary flow region of the bypass channel corresponds to the flow region in which the fluid medium flows around, rather than flows over, the at least one interference element.

Consequently, the primary flow region is the region in the bypass channel into which the at least one interference element does not extend.

By means of the overflow region, in some regions, an altered, in particular reduced, flow cross section can be configured in order to form the flow resistance in the bypass channel. As a result, an increased pressure loss for the fluid medium flowing through the bypass channel can be achieved.

Preferably, by means of the overflow region of the at least one interference element, an at least partial flow turbulence, flow deflection and/or flow obstruction of the fluid medium flowing through the bypass channel can be provided.

An advantageous further development of the bipolar plate can moreover provide that the flow cross section of the bypass channel in the overflow region is configured to be at least 25%, preferably at least 50%, particularly preferably at least 75%, smaller than the flow cross section of the bypass channel in the primary flow region.

In other words, in the region of the bypass channel, which is formed by the overflow region, a reduction of the flow cross section by 25% or more, preferably 50% or more, particularly preferably 75% or more, can be provided in relation to the flow cross section in the primary flow region of the bypass channel.

By means of such a reduction of the flow cross section in the region of the overflow region, a defined flow resistance can be configured for the fluid medium in the bypass channel, in order to reduce the volume flow flowing through the bypass channel and to optimize a throughflow of the flow field of the bipolar plate.

In a further advantageous configuration of the bipolar plate, the at least one interference element can form an at least partially plateau-shaped overflow region.

The plateau-shaped overflow region preferably extends essentially parallel to a primary plane of extension of the bipolar plate body.

A plateau level which is formed by the plateau-shaped overflow region can thus extend essentially parallel to the primary plane of extension of the bipolar plate body.

The plateau-shaped overflow region of the at least one interference element can advantageously comprise an at least partially structured surface, for example projections, recesses, grooves, etc.

Such a structured surface of the plateau-shaped overflow region can generate an additional flow resistance on account of flow turbulences and the like and can generate an associated additional pressure loss in the bypass channel.

In a particularly preferred configuration of the bipolar plate, the plateau-shaped overflow region can comprise at least two continuous plateau sections which extend, to a different extent, from the edge flange and/or from the delimiting device into the bypass channel.

In particular, the plateau-shaped overflow region of the at least one interference element, in a plan view, can have an arbitrary geometrical configuration.

The plateau-shaped overflow region can advantageously comprise one plateau section, in particular a plateau section which is configured on the edge flange and/or on the delimiting device and from which at least one further plateau section extends further into the bypass channel.

For example, the plateau-shaped overflow region of the at least one interference element can be formed by two rectangular plateau sections which, in a plan view, have a L-shaped geometry, in which one leg of the L-shaped overflow region extends further into the bypass channel.

It can also be provided that the plateau-shaped overflow region of the at least one interference element is formed by multiple plateau sections which are configured to be longer and/or shorter.

Particularly preferably, in the case of the bipolar plate, it can be provided that multiple mutually spaced interference elements are provided in the bypass channel, which respectively form overflow regions and flow-around regions for the fluid medium in the bypass channel.

In particular, multiple interference elements extend spaced apart from one another from the edge flange and from the delimiting device into the bypass channel and respectively form overflow regions and flow-around regions for the fluid medium.

The flow-around regions of the interference elements which are configured on the edge flange and on the delimiting device preferably form a meandering primary flow region.

In particular, the interference elements, which are configured on the edge flange, and the interference elements, which are configured on the delimiting device, can be arranged offset from one another and can thus form the meandering flow path in the bypass channel.

In this manner, by means of the multiple interference elements, a meandering primary flow path can be configured in combination with a multiplicity of flow-around regions in the bypass channel.

By means of the meandering flow path, a repeated flow deflection for the fluid medium flowing in the bypass channel can be configured. As a result, a further increase of the flow resistance in the bypass channel can be achieved.

Depending on the number and/or distribution of the multiple interference elements, the flow resistance for the fluid medium flowing through the bypass channel can be adjustable, and the pressure loss can thus be adaptable.

By means of the multiple interference elements, a significantly lower volume flow of the fluid medium can flow through the bypass channel, and a higher volume flow of the fluid medium can flow through the flow field of the bipolar plate.

A preferred configuration of the bipolar plate can moreover provide that the interference elements formed on the edge flange and the interference elements formed on the delimiting device have differently configured overflow regions.

Preferably, on the edge flange and on the delimiting device respectively, interference elements having geometrically differently configured overflow regions are provided in a mutually alternating manner.

In the case of the bipolar plate, it can advantageously be provided that the differently configured overflow regions are formed by plateau-shaped and/or web-shaped interference elements which are preferably arranged in the bypass channel in an alternating manner.

Particularly preferably, interference elements are configured on the edge flange, which in each case have a plateau-shaped overflow region, and interference elements having an overflow region are configured on the delimiting device, which extend into the bypass channel in a web-shaped or tongue-shaped manner.

However, the geometrical configuration of the overflow regions is not limited to the above-described embodiments; instead, the overflow regions can have arbitrary configurations which are suitable for forming a significant flow resistance in the bypass channel.

The object is moreover fulfilled by a bipolar plate assembly for a fuel cell unit, comprising multiple bipolar plates according to one of the above-described embodiments, arranged in a stack, wherein the bypass channel, at least in some regions, is delimited by adjacent bipolar plates, and at least one interference element is formed in the bypass channel by the bipolar plate body of a bipolar plate, and at least one further interference element is formed by the bipolar plate body of an adjacent bipolar plate.

The bipolar plates are preferably an upper bipolar plate and a lower bipolar plate of a fuel cell stack.

In particular, the bypass channel is formed by the bipolar plate bodies of one bipolar plate and of the adjacent bipolar plate, i.e. by the upper and lower bipolar plates.

A further development of the bipolar plate assembly can moreover provide that the at least one interference element of one bipolar plate and the at least one further interference element of the adjacent bipolar plate are arranged offset from one another and/or, at least in some regions, overlapping one another in the bypass channel.

In particular, multiple interference elements are formed by the bipolar plate bodies of one bipolar plate and of the adjacent bipolar plate, wherein the interference elements, in a plan view of the bipolar plate assembly, can be provided both offset from one another and, at least in some regions, overlapping one another on the bipolar plates.

Multiple interference elements can preferably be provided at least in some regions opposite one another on one bipolar plate and on the adjacent bipolar plate.

It is preferably provided that, between mutually opposite interference elements or between mutually overlapping overflow regions of these interference elements, a clearance is formed, such that a flow cross section for the fluid medium is formed therebetween.

It is also possible for a clearance of this type not to be provided, such that a region of the flow cross section of the bypass channel is entirely obstructed by the mutually opposite interference elements.

By interference elements arranged offset from one another, in particular, overflow regions provided offset from one another and flow-around regions can be configured in the bypass channel.

In an advantageous configuration of the bipolar plate assembly, a plateau section of an interference element of one bipolar plate and a plateau section of an interference element of the adjacent bipolar plate, at least in some regions, can be arranged overlapping one another, and at least one subsection of the plateau section of the interference element of one bipolar plate, which extends further into the bypass channel, and at least one subsection of the plateau section of the interference element of the adjacent bipolar plate, which extends further into the bypass channel, can be arranged offset from one another.

Advantageously, a subsection of the plateau section of the lower interference element and a subsection of the plateau section of the upper interference element, in the plan view, can be arranged completely overlapping one another in the bypass channel.

A further subsection of the plateau section of the lower interference element and a further subsection of the plateau section of the upper interference element, which subsections respectively extend further into the bypass channel, can preferably be arranged offset from one another.

For example, the lower interference element of the lower bipolar plate and the upper interference element of the upper bipolar plate, in the plan view, can respectively have an L-shaped contour, in which one leg of the L-shaped contour extends further into the bypass channel.

Particularly preferably, it can be provided that the L-shaped lower interference element and the L-shaped upper interference element are configured offset from one another such that the two interference elements, in combination, form a U-shaped contour in the plan view.

In this manner, it can be prevented that a core flow is formed, which flows linearly along the primary direction of extension of the bypass channel and is not obstructed, deflected or the like by the interference elements. As a result, the formation of dead space regions between the interference elements can be avoided and a negative effect on the pressure loss can be prevented.

A further development of the bipolar plate assembly can provide that, on a plate side of the bipolar plate body, which is opposite the flow field, a flow structure for a further fluid medium is configured in a manner corresponding to the flow field, and the at least one delimiting device for the further fluid medium forms a flow region on this plate side, wherein at least one passage is provided, by means of which a fluidic connection is configured between the flow region, which is formed by the delimiting device, and the flow structure.

In particular, the further fluid medium can be a coolant.

Accordingly, the flow structure which is provided on the opposing plate side of the bipolar plate body is preferably a cooling structure for cooling the bipolar plate assembly. For cooling, the coolant is able to flow through this flow structure.

By means of the delimiting device, the flow region for the further fluid medium is configured in particular as a flow channel on the opposing plate side of the bipolar plate body.

Via the at least one passage, the further fluid medium can flow between the flow region, which is formed by the delimiting device, and the flow structure, i.e. the cooling structure, which is configured in a manner corresponding to the flow field.

An advantageous configuration of the bipolar plate assembly can moreover provide that the at least one passage which forms the fluidic connection is configured between the at least one interference element which is integrally formed with the delimiting device and the edge flange which, at least in sections, delimits the flow field.

By means of the edge flange, a flow channel for the further fluid medium is formed on the opposing plate side of the bipolar plate body, which flow channel forms a flow region of the flow structure for the further fluid medium.

On the opposing plate side, the at least one passage preferably extends between the at least one interference element which extends into the bypass channel and the flow channel which is formed by the edge flange. As a result, the further fluid medium can flow from the flow region, which is formed by the delimiting device and the at least one interference element, via the passage into the flow channel, which is formed by the edge flange, and can be distributed in the flow structure.

The passage can be incorporated in the bipolar plate body, for example, on the opposing plate side between the at least one interference element and the edge flange or can be formed by a structure of an adjacent bipolar plate body.

In a further preferred configuration of the bipolar plate assembly, the at least one passage can be formed by an offset of a plate section of the bipolar plate body, which is provided between the interference element and the edge flange, and a structure section of a flow structure of an adjacent bipolar plate body.

The corresponding structure of the adjacent bipolar plate body can preferably be configured such that the passage between the interference element and the edge flange is provided by the configuration of the structure section of the adjacent bipolar plate body.

Advantageously, the passage can be formed by the structure of the adjacent bipolar plate body in a manner at least partially corresponding to the plate section of the bipolar plate body which is provided between the interference element and the edge flange.

The object is further fulfilled by a fuel cell unit comprising at least one membrane-electrode unit and at least one bipolar plate according to one of the above-described embodiments or at least one bipolar plate assembly according to one of the above-described embodiments.

The fuel cell unit comprises an arbitrary fuel cell having bipolar plates for forming a fuel cell stack. For example, the fuel cell unit can comprise a polymer electrolyte fuel cell (PMFC), an alkaline fuel cell (AFC), a direct methanol fuel cell (DMFC) or a phosphoric acid fuel cell (PAFC).

In particular, the fuel cell unit comprised a multiplicity of membrane-electrode units which are stacked in a stacking direction to form a fuel cell stack, wherein in each case a bipolar plate or bipolar plate assembly of this type is provided between the membrane-electrode units.

In particular, a bipolar plate is respectively arranged on an anode side and on a cathode side of the membrane-electrode unit.

By means of the bipolar plate or bipolar plate assembly, an anode space is formed on the anode side and a cathode space is formed on the cathode side, via which the fluid medium (e.g. process gases) is supplied and/or evacuated for the fuel cell reaction.

By means of a fuel cell unit having a bipolar plate or bipolar plate assembly of this type, an improved supply and evacuation of the fluid medium to/from the membrane-electrode unit can be provided, as a result of which an optimized performance potential of the fuel cell unit can be achieved. By means of the bipolar plate, maximization of the power density of the membrane-electrode unit can thus be achievable, such that the fuel cell unit can have improved efficiency.

Further preferred features and/or advantages of the invention are the subject matter of the following description and of the graphical representation of exemplary embodiments.

### BRIEF DESCRIPTION OF THE DRAWINGS

FIG. 1 shows a schematic partial view of a bipolar plate according to one embodiment according to the disclosure;

FIG. 2 shows a schematic partial view of a bipolar plate assembly according to one embodiment according to the disclosure;

FIG. 3 shows a schematic partial view of a bipolar plate assembly according to a second embodiment according to the disclosure;

FIG. 4 shows a perspective sectional view of the bipolar plate assembly in FIG. 3 along section A-A in FIG. 3.

In all the figures, identical or functionally equivalent elements are provided with the same reference signs.

### DETAILED DESCRIPTION OF THE DRAWINGS

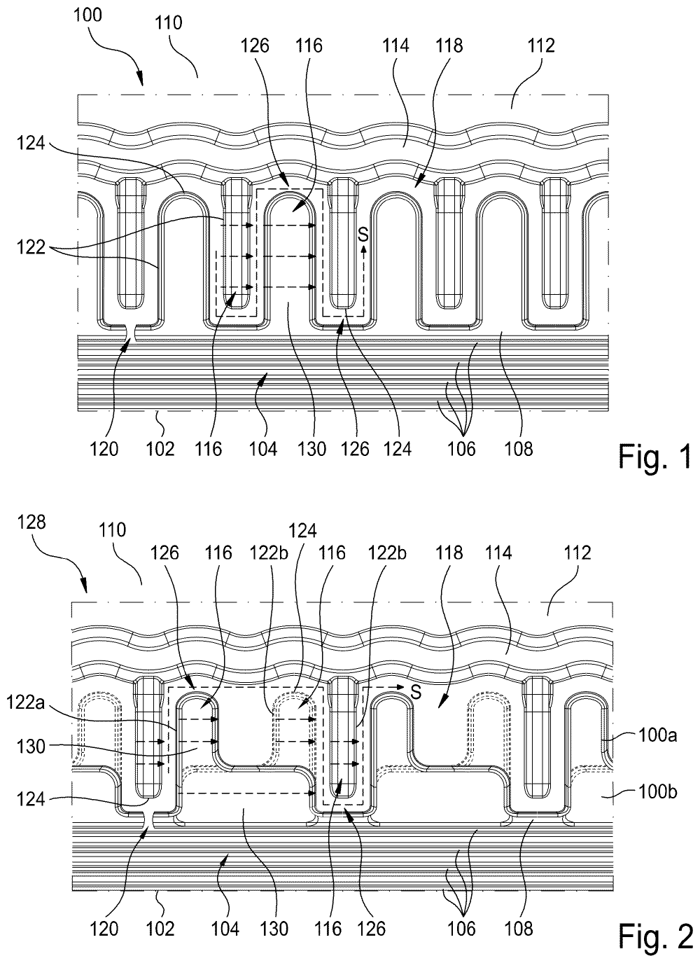

FIG. 1 shows a schematic partial view of a bipolar plate, which is designated overall by 100, for a fuel cell unit (not shown in greater detail) according to a first embodiment according to the disclosure.

The fuel cell unit comprises a fuel cell which is formed by one or more fuel cell elements. The fuel cell elements form a fuel cell stack.

The fuel cell can be an arbitrary fuel cell which comprises bipolar plates for forming the fuel cell stack, for example a polymer electrolyte fuel cell (PMFC), an alkaline fuel cell (AFC), a direct methanol fuel cell (DMFC) or a phosphoric acid fuel cell (PAFC).

The fuel cell comprises an infeed for supplying a fluid medium to the fuel cell, in particular a fuel, fuel mixture (fuel-offgas mixture), oxidizer and/or coolant. Via an outlet of the fuel cell, the offgas, the fuel, the oxidizer and/or the coolant are evacuated.

The fuel cell stack comprises a multiplicity of membrane-electrode units which are stacked in a stacking direction. In each case, a bipolar plate 100 is arranged between the membrane-electrode units. This means that, in each case, a bipolar plate 100 is arranged on an anode side and on a cathode side of a membrane-electrode unit.

In other words, the bipolar plate 100 forms the anode side of one membrane-electrode unit and the cathode side of an adjacent membrane-electrode unit.

The bipolar plate 100 is configured to provide a uniform distribution and supply of the fluid medium to the membrane-electrode units and to ensure the evacuation of the fluid medium.

To this end, the bipolar plate 100 is formed of one or more bipolar plate bodies 102, on which a flow field 104 for the fluid medium is configured.

The flow field 104 is formed by a multiplicity of flow channels 106 through which the fluid medium can flow.

The flow field 104 can be configured by an arbitrary course of the flow channels 106, by means of which an optimum distribution of the fluid medium is achieved.

The flow channels 106 are preferably formed from the at least one bipolar plate body 102; in particular, they are molded therefrom, molded thereon or incorporated therein.

The bipolar plate body 102 can be configured of metal, graphite, a graphite-polymer composition or of ceramic.

The surface of the bipolar plate body 102 can be provided with a coating, for example platinum or palladium.

Configured on the bipolar plate body 102 is an edge flange 108, which delimits the flow field 104 at an outer region 122 or an outer side 110 of the bipolar plate 100.

The edge flange 108 is thus an element which delimits an outermost flow channel 106 of the flow field 104 vis-à-vis the edge region 112 of the bipolar plate 100 or vis-à-vis the outer side 110 of the bipolar plate 100.

As per the remaining structure of the flow channels 106, the edge flange 108 is molded from the bipolar plate body 102, molded thereon or incorporated therein.

A delimiting device 114 is provided at a distance from the edge flange 108 towards the outer side 110.

By means of the delimiting device 114, a fluidic delimitation of the flow field 104 is formed vis-à-vis the edge region 112 of the bipolar plate 100 or vis-à-vis the outer side 110 of the bipolar plate 100.

The delimiting device 114 is preferably configured as a bead which is molded by the bipolar plate body 102, molded thereon or incorporated therein.

In one direction of extension, the delimiting device 114 can be configured both with a curved or undulating profile and also with a linear profile.

Alternatively, the delimiting device 114 can also be configured as a sealing element.

A sealing element of this type can preferably be formed of an elastomer material. Said sealing element can be fitted to the bipolar plate body 102 in an arbitrary form, for example applied, molded, adhesive bonded, welded or the like thereto.

A bypass channel 118 is formed between the delimiting device 114 and the edge flange 108.

The bypass channel 118 is a flow region or flow channel which is structurally formed by the clearance between the delimiting device 114 and the edge flange 108.

A passage 120 forms a fluidic connection between the bypass channel 118 and the flow field 104.

In particular, the passage 120 is configured by an interruption in the edge flange 106.

In particular, the passage 120 is a structural interruption in the edge flange 106, which interruption is also referred to as a weld gate.

The bypass channel 118 bypasses the flow field 104 at least in some regions.

As a result of the passage 120, a partial volume flow of the fluid medium flowing through the flow field 104 flows into the bypass channel 118.

The partial volume flow of the fluid medium flowing through the bypass channel 118 bypasses the flow field 104 at least in some regions.

As a partial volume flow of the fluid medium flowing through the bypass channel 118 is not available, or is only partially available, to the membrane-electrode unit for the fuel cell reaction, a loss of efficiency of the fuel cell can result therefrom, such that this partial volume flow should be kept as small as possible.

For this reason, multiple interference elements 122 are configured in the bypass channel 118, by means of which a flow resistance for the fluid medium is configured in the bypass channel 118.

The interference elements 122 are arranged in the bypass channel 118 such that, in some regions, an altered, in particular a reduced, flow cross section of the bypass channel 118 is configured.

By means of each of the interference elements 122, a partial flow impairment, flow turbulence and/or flow deflection of the fluid medium within the bypass channel 118 can thus be configured.

In this manner, by means of the interference elements 122, an increased pressure loss is generated when the fluid medium flows through the bypass channel 118.

As a result of the flow resistance formed by the interference elements 122, it can be achieved that a reduced volume flow of the fluid medium flows through the bypass channel 118 and an increased volume flow flows through the flow field 104.

The flow resistance in the bypass channel 118 can be adjustable by means of the configuration, the number, the arrangement and/or the orientation of the interference elements 122.

The interference elements 122 are preferably formed by the bipolar plate body 102, are preferably molded from the bipolar plate body 102, molded thereon or incorporated therein.

In particular, the multiple interference elements 122 can be configured integrally with the edge flange 108 and with the delimiting device 114.

Alternatively, the interference elements 122 can also be arranged as separate elements in the bypass channel 118.

The interference elements 122 are arranged spaced apart from one another in the bypass channel 118.

In particular, the interference elements 122 are configured spaced apart from one another on the edge flange 108 and on the delimiting device 114.

The interference elements 122 preferably extend at essentially right angles from the edge flange 108 and from the delimiting device 114 into the bypass channel 118.

In particular, the interference elements 122 are essentially oriented orthogonally to a primary direction of extension of the bypass channel 118.

It can also be provided that the interference elements 122 extend from the edge flange 108 and/or from the delimiting device 114 into the bypass channel 118 inclined at an angle.

The interference elements 122 can preferably have a length which is greater than half a width of the bypass channel 118.

As represented in FIGS. 1 and 2, the interference elements 122 preferably have a mutually differing geometrical configuration.

The interference elements 122 can preferably extend from the delimiting device 114 into the bypass channel 118 in a web-shaped manner.

Further preferably, the interference elements 122 can extend from the edge flange 108 into the bypass channel 118 in a tongue-shaped manner.

Conversely, it is understood that the interference elements 122 can also extend from the edge flange 108 into the bypass channel 118 in a web-shaped manner and the interference elements 122 can extend from the delimiting device 114 into the bypass channel 118 in a tongue-shaped manner.

However, the interference elements 122 are not limited to a web-shaped and/or tongue-shaped configuration of this type, but can have another arbitrary geometrical configuration.

In particular, the interference elements 122 which are configured on the edge flange 108 and the interference elements 122 which are configured on the delimiting device 114 are arranged offset from one another in the bypass channel 118.

As the interference elements 122 which are configured on the edge flange 108 are arranged offset from the interference elements 122 which are configured on the delimiting device 114, a meandering primary flow region S for the fluid medium is formed in the bypass channel 118.

By means of this meandering primary flow region S, a repeated flow deflection of the fluid medium flowing in the bypass channel 118 is provided by the interference elements 122. As a result, a significant increase of the flow resistance in the bypass channel 118 can be provided.

The primary flow region S comprises multiple flow-around regions 126.

The flow-around regions 126 are flow regions of the bypass channel 118 which are configured about end sections 124 of the interference elements 122.

In the flow-around regions 126, a flow of the fluid medium around the end sections 124 of the interference elements 122 is provided.

In the flow-around regions 126, a deflection of the flow path for the fluid medium is provided about the end sections 124 of the interference elements 122.

The end sections 124 of the interference elements 122 can preferably be configured to be rounded.

In each case, by means of the flow-around regions 126, a deflection of the flow path of the fluid medium through approximately or 90° or 180° about the respective end section 124 of the interference element 122 can be preferably provided.

In particular, the interference elements 122 are configured such that, by means thereof, overflow regions 116 are additionally formed in the bypass channel 118.

The fluid medium thus flows both around (along the flow-around regions 126) and over the interference elements 122 (along the overflow regions 116).

Overflow of the interference element 122 is to be understood to mean that a partial volume flow of the fluid medium flowing in the bypass channel 118 flows in the direction of a longitudinal extension of the bypass channel 118 across the interference element 122.

In particular, the overflow region 116 is formed such that a clearance or gap between the interference element 122 and a bipolar plate body 102 which is opposite the interference element 122 and also delimits the bypass channel 122, is configured.

For example, the overflow region 116 is configured by a gap between a ridge or plateau of the interference element 122 and the opposing bipolar plate body 102.

The overflow region 116 forms a flow cross section between the interference element 122 and the opposing bipolar plate body 102.

An overall flow cross section of the bypass channel 118 is formed by a flow cross section in the primary flow region S of the bypass channel 118 and the flow cross section in the overflow region 116 of the interference element 122.

The overflow region 116 of the interference element 122 has an overflowable cross-sectional height between the interference element 122 and the opposing bipolar plate body 102, which is configured to be smaller than a cross-sectional height of the bypass channel 118 in the primary flow region S.

In particular, the flow cross section of the bypass channel 118 in the region of the overflow region 116 of the interference element 122, i.e. the region between the interference element 122 and the opposing bipolar plate body 102, is configured to be smaller than the flow cross section of the bypass channel 118 in the primary flow region S.

Preferably, the magnitude of the flow cross section of the bypass channel 118 in the overflow region 116 can be configured to be at least 25% smaller than the flow cross section of the bypass channel 118 in the primary flow region S.

Further preferably, the magnitude of the flow cross section of the bypass channel 118 in the overflow region 116 can be configured to be at least 50% smaller than the flow cross section of the bypass channel 118 in the primary flow region S.

Particularly preferably, the magnitude of the flow cross section of the bypass channel 118 in the overflow region 116 can be configured to be at least 75% smaller than the flow cross section of the bypass channel 118 in the primary flow region S.

As already explained above, the interference elements 122 formed on the edge flange 108 and the interference elements 122 formed on the delimiting device 114 have differently configured overflow regions 116.

The interference elements 122 formed on the delimiting device 114 have a web-shaped overflow region 116.

The interference elements 122 formed on the edge flange 108 have a plateau-shaped overflow region 116.

The plateau-shaped overflow region 116 of the interference element 122 which is configured on the edge flange 108 is formed by a plateau section 130 which is configured on an upper side of the interference element 122 which faces the bypass channel 118.

In a plan view of the bipolar plate 100, the plateau section 130 forms a planar, i.e. plateau-shaped, upper side of the interference element 122.

The plateau section 130 of the plateau-shaped overflow region 116 preferably extends essentially parallel to a primary plane of extension of the bipolar plate body 102.

The plateau section 130 can preferably extend essentially along the entire upper side of the interference element 122 which faces the bypass channel 118.

Preferably, the differently configured overflow regions 116 of the interference elements 122, i.e. the web-shaped interference elements 122 and the plateau-shaped interference elements 122, are arranged in the bypass channel 118 in an alternating manner.

FIG. 2 shows a schematic partial view of a bipolar plate assembly 128 according to one embodiment according to the disclosure using the example of two mutually adjacently arranged bipolar plates 100.

Hereinafter, only the distinctions of this second embodiment from the first embodiment will be discussed, and equivalent configurations will not be described in further detail and correspond to those of the first embodiment, unless indicated otherwise.

FIG. 2 shows by way of example the bipolar plate assembly 128 with reference to two adjacent bipolar plates 100, i.e. which are stacked one on top of the other.

Accordingly, the bipolar plate assembly 128 comprises a first bipolar plate 100, hereinafter the lower bipolar plate 100a, and an adjacent bipolar plate 100, hereinafter the upper bipolar plate 100b.

The bipolar plate assembly 128 of a fuel cell stack is formed by a multiplicity of bipolar plates 100 stacked one on top of another.

The bypass channel 118 is delimited by the lower bipolar plate 100a and the upper bipolar plate 100b.

In the bypass channel 118, multiple interference elements 122a are formed by the bipolar plate body 102 of the lower bipolar plate 100a, and multiple interference elements 122b are formed by the bipolar plate body 102 of the upper bipolar plate 100b.

In other words, in a side view of the bipolar plate assembly 128, i.e. in the plane of extension of the bipolar plates 100, in the bypass channel 118, lower interference elements 122a are formed on the lower bipolar plate 100a, and upper interference elements 122b are formed on the upper bipolar plate 100b.

Preferably, the interference elements 122a/b which are formed on the lower and/or on the upper bipolar plate 100a/b, at least in some regions, are arranged offset from one another.

Further preferably, the interference elements 122a/b which are formed on the lower and/or on the upper bipolar plate 100a/b can be differently configured.

The interference elements 122a/b which are formed on the lower and/or on the upper bipolar plate 100a/b can be both web-shaped interference elements 122a/b and plateau-shaped interference elements 122a/b.

In this embodiment, in particular, it can be provided that the plateau-shaped interference elements 122a/b which are provided on the lower bipolar plate 100a and on the upper bipolar plate 100b are configured such that the plateau sections 130 thereof, in the plan view of the bipolar plate 100, in some regions, are arranged overlapping one another and, in some regions, are arranged offset from one another.

In particular, an interspace is provided between the interference elements 122a of the lower bipolar plate 100a and the interference elements 122b of the upper bipolar plate 100b, by which the overflow region 116 is formed.

In other words, the lower interference elements 122a of the lower bipolar plate 100a and the upper interference elements 122b of the upper bipolar plate 100b are provided spaced apart from one another.

The plateau section 130 of the plateau-shaped interference element 122a/b is preferably formed by two continuous subsections.

The two continuous subsections of the plateau section 130 preferably have a mutually differing geometrical configuration.

Preferably, the two subsections of the plateau section 130 are configured to be rectangular.

In particular, the two subsections of the plateau section 130 of the interference element 122 extend to a different extent from the edge flange 108 into the bypass channel 118.

Further preferably, one of the two subsections of the plateau section 130, in the plan view, is configured to be larger than the other subsection of the plateau section 130, wherein the smaller subsection of the plateau section 130 connects to the larger subsection of the plateau section 130 and extends further into the bypass channel 118.

The smaller subsection of the plateau section 130 is preferably provided on a side region of the larger subsection of the plateau section 130.

In the plan view, the interference element 122a/b, as a result of the plateau section 130 having the two differently configured subsections, can have an L-shaped contour.

The L-shaped lower interference element 122a of the lower bipolar plate 100a and the L-shaped upper interference element 122b of the upper bipolar plate 100b are preferably arranged offset from one another such that the two interference elements 122a/b, in combination, form a U-shaped contour in the plan view.

In particular, it can be provided that one subsection of the plateau section 130 of the lower interference element 122a and of the upper interference element 122b, in the plan view, entirely overlap and a further subsection of the plateau section 130 of the lower interference element 122a and of the upper interference element 122b, which extend further into the bypass channel 118, are arranged offset from one another.

In this manner, it can effectively be prevented that no core flow is formed within the bypass channel 118, which would flow linearly along the primary direction of extension of the bypass channel 118 and would negatively affect the desired pressure loss.

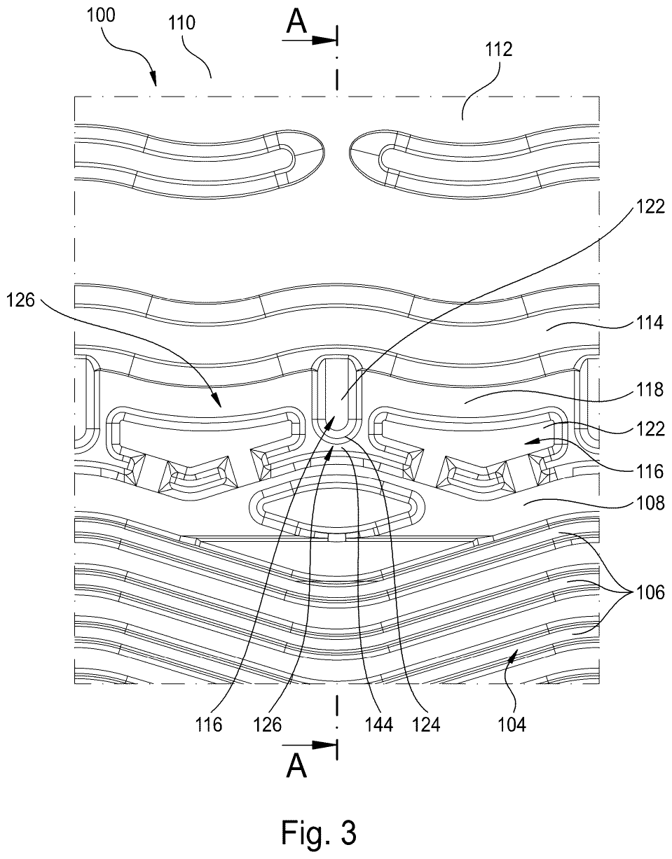

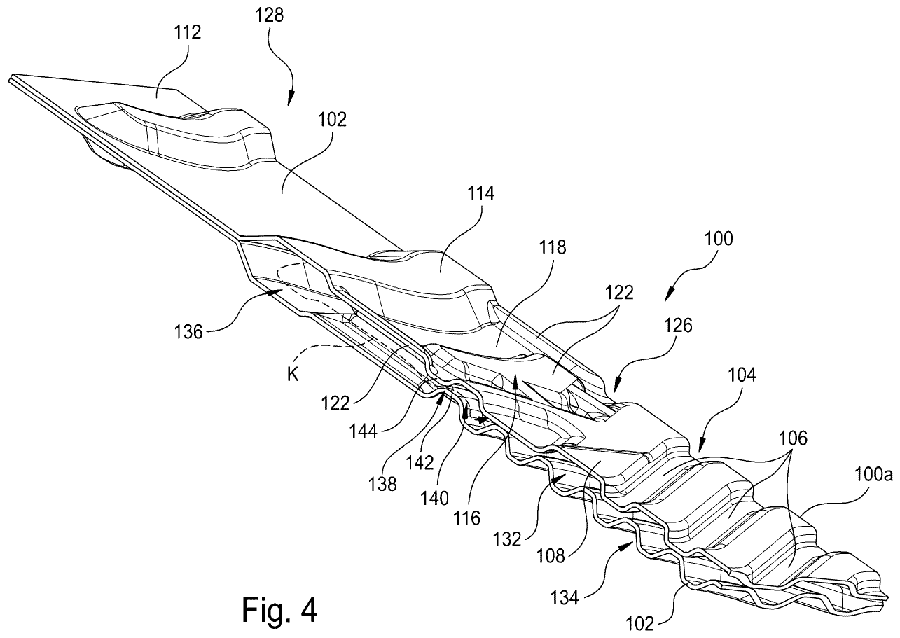

In FIGS. 3 and 4, a bipolar plate assembly 128 according to a second embodiment according to the disclosure is shown, wherein the bipolar plate assembly 128 is shown in FIG. 3 in a schematic plan view and in FIG. 4 in a perspective sectional view along section A-A in FIG. 3.

Features which are not discussed in greater detail hereinafter essentially correspond to the embodiments according to FIGS. 1 and/or 2 such that, hereinafter, only the distinctions of this embodiment are described and equivalent configurations are not explained in greater detail.

In FIGS. 3 and 4, the lower bipolar plate 100a is shown, on which a further bipolar plate body 102 is arranged, as can be seen in FIG. 4.

The sectional view according to FIG. 4 illustrates that, in this embodiment of the bipolar plate assembly 128, on a plate side of the bipolar plate 100a which is opposite the flow field 104, a flow structure 132 is formed for a further fluid medium, in particular for a coolant.

The flow structure 132 preferably forms a cooling structure through which the coolant flows.

In particular, the flow structure 132 is delimited by the adjacently arranged bipolar plate body 102 on which a correspondingly configured structure 134 is formed.

The flow structure 132 can be formed by a multiplicity of flow channels.

By means of the delimiting device 114, a flow region 136 is formed on the opposing plate side of the bipolar plate 100a, through which the further fluid medium can also flow.

This flow region 136, on this plate side of the bipolar plate 100a, preferably extends into the interference element 122 which is integrally configured with the delimiting device 114, as illustrated in FIG. 4 by the flow path K.

Between the flow region 136, which is formed by the delimiting device 114, and the flow structure 132, a passage 138 is configured, by means of which a fluidic connection for the further fluid medium is configured.

The flow path K of the further fluid medium, which is represented in FIG. 4, illustrates the fluidic connection which is formed by the passage 138.

The bipolar plate assembly 128 can comprise multiple such passages 138 between the flow region 136, which is formed by the delimiting device 114, and the flow structure 132.

In particular, the passage 138 which forms the fluidic connection is configured on the opposing plate side between the interference element 122 which is integrally formed with the delimiting device 114 and the edge flange 108 which delimits the flow field 104.

By means of the edge flange 108, a flow channel 140 of the flow structure 132 is formed on the opposing plate side of the bipolar plate 100a, which forms an outermost flow channel 140 of the flow structure 132. The flow channel 140 can delimit the flow structure 132 at least in some regions.

Consequently, the passage 138 extends on the opposing plate side between the interference element 122 which extends into the bypass channel 118 and the flow channel 140 which is formed by the edge flange 108.

In this manner, the further fluid medium can flow from the flow region 136, which is formed by the delimiting device 114 and the interference element 122, through the passage 138 into the flow channel 140, which is formed by the edge flange 108, and of the flow structure 132 connected fluidically thereto.

The passage 138 can be molded at the opposing plate side between the interference element 122 and the edge flange 108 into the bipolar plate 100a and/or can be configured by a defined configuration of the corresponding structure 134 of the adjacent bipolar plate body 102.

In particular, a structure section 142 of the structure 134 of the adjacent bipolar plate body 102 can be configured such that this section is arranged offset from a plate section 144 of the bipolar plate body 100a which extends between the interference element 122 and the edge flange 108.

As this structure section 142 of the structure 134 of the adjacent bipolar plate body 102 is arranged in the region of the plate section 144 of the bipolar plate 100a offset therefrom, the passage 138 is formed between the flow region 136 and the flow structure 132.

### LIST OF REFERENCE SIGNS

100 Bipolar plate
100a Lower bipolar plate
100b Upper bipolar plate
102 Bipolar plate body
104 Flow field
106 Flow channels
108 Edge flange
110 Outer side
112 Edge region
114 Delimiting device
116 Overflow region
118 Bypass channel
120 Passage
122 Interference element
124 End section
126 Flow-around region
128 Bipolar plate assembly
130 Plateau section
132 Flow structure
134 Corresponding structure
136 Flow region
138 Passage
140 Flow channel
142 Structure section
144 Plate section
S Primary flow path
K Flow path of the further fluid medium

1. A bipolar plate for a fuel cell unit, said bipolar plate comprising:
at least one bipolar plate body, wherein
multiple flow channels are configured, which form at least one flow field for a fluid medium,
at least one edge flange is configured, which delimits the flow field at least in sections,
at least one delimiting device is provided, which is arranged in relation to the edge flange such that a bypass channel is formed between the edge flange and the delimiting device,
at least one passage is configured, by means of which a fluidic connection is provided between the flow field and the bypass channel, and
in the bypass channel, at least one interference element is provided, which forms an overflow region for the fluid medium.

2. The bipolar plate as claimed in claim 1, wherein the at least one interference element is formed by the bipolar plate body and/or is arranged as a separate element in the bypass channel.

3. The bipolar plate as claimed in claim 1, wherein the at least one interference element is integrally configured with the edge flange and/or with the delimiting device and extends from the edge flange and/or from the delimiting device into the bypass channel.

4. The bipolar plate as claimed in claim 1, wherein a cross-sectional height of the bypass channel in the overflow region of the interference element is configured to be smaller than a cross-sectional height of the bypass channel in a primary flow region.

5. The bipolar plate as claimed in claim 1, wherein a flow cross section of the bypass channel in the overflow region is configured to be smaller than a flow cross section of the bypass channel in a primary flow region.

6. The bipolar plate as claimed in claim 5, wherein the flow cross section of the bypass channel in the overflow region is configured to be at least 25%, at least 50%, or at least 75%, smaller than the flow cross section of the bypass channel in the primary flow region.

7. The bipolar plate as claimed in claim 1, wherein the at least one interference element forms an at least partially plateau-shaped overflow region.

8. The bipolar plate as claimed in claim 7, wherein the plateau-shaped overflow region comprises at least two continuous plateau sections which extend to a different extent from the edge flange and/or from the delimiting device into the bypass channel.

9. The bipolar plate as claimed in claim 1, wherein multiple interference elements, which are arranged spaced apart from one another and respectively form overflow regions and flow-around regions for the fluid medium in the bypass channel, are provided in the bypass channel, wherein the flow-around regions of the interference elements are configured on the edge flange and on the delimiting device, and wherein, optionally, the flow-around regions of the interference elements form a meandering primary flow region.

10. The bipolar plate as claimed in claim 9, wherein the interference elements formed on the edge flange and the interference elements formed on the delimiting device have differently configured overflow regions.

11. The bipolar plate as claimed in claim 10, wherein the differently configured overflow regions are formed by plateau-shaped and/or web-shaped interference elements, and wherein, optionally, the plateau-shaped and/or web-shaped interference elements are arranged in the bypass channel in an alternating manner.

12. A bipolar plate assembly for a fuel cell unit, comprising multiple bipolar plates as claimed in claim 1, which are arranged in a stack, wherein the bypass channel at least in some regions is delimited by adjacent bipolar plates, and at least one interference element is formed in the bypass channel by the bipolar plate body of a bipolar plate, and at least one further interference element is formed by the bipolar plate body of an adjacent bipolar plate.

13. The bipolar plate assembly as claimed in claim 12, wherein the at least one interference element of one bipolar plate and the at least one further interference element of the adjacent bipolar plate are arranged offset from one another and/or at least in some regions overlapping one another in the bypass channel.

14. The bipolar plate assembly as claimed in claim 12, wherein a plateau section of an interference element of one bipolar plate and a plateau section of an interference element of the adjacent bipolar plate at least in some regions are arranged overlapping one another, and at least one subsection of the plateau section of the interference element of one bipolar plate, which extends further into the bypass channel, and at least one subsection of the plateau section of the interference element of the adjacent bipolar plate, which extends further into the bypass channel, are arranged offset from one another.

15. The bipolar plate assembly as claimed in claim 12, wherein, on a plate side of the bipolar plate body which is opposite the flow field, a flow structure for a further fluid medium is provided in a manner corresponding to the flow field, and the at least one delimiting device for the further fluid medium forms a flow region on this plate side, wherein at least one passage is provided, by means of which a fluidic connection is configured between the flow region, which is formed by the delimiting device, and the flow structure.

16. The bipolar plate assembly as claimed in claim 15, wherein the at least one passage, which forms the fluidic connection, is configured between the at least one interference element, which is integrally formed with the delimiting device, and the edge flange, which at least in sections delimits the flow field.

17. The bipolar plate assembly as claimed in claim 15, wherein the at least one passage is formed by an offset of a plate section of the bipolar plate body, which is provided between the interference element and the edge flange, and a structure section of a flow structure of an adjacent bipolar plate body.

18. A fuel cell unit comprising at least one membrane-electrode unit and at least one bipolar plate, said at least one bipolar plate comprising:
at least one bipolar plate body, wherein
multiple flow channels are configured, which form at least one flow field for a fluid medium,
at least one edge flange is configured, which delimits the flow field at least in sections,
at least one delimiting device is provided, which is arranged in relation to the edge flange such that a bypass channel is formed between the edge flange and the delimiting device,
at least one passage is configured, by means of which a fluidic connection is provided between the flow field and the bypass channel, and
in the bypass channel, at least one interference element is provided, which forms an overflow region for the fluid medium, or wherein
the fuel cell unit comprising at least one bipolar plate assembly, said at least one bipolar plate assembly comprising multiple of said bipolar plates, which are arranged in a stack, wherein the bypass channel at least in some regions is delimited by adjacent bipolar plates, and at least one interference element is formed in the bypass channel by the bipolar plate body of a bipolar plate, and at least one further interference element is formed by the bipolar plate body of an adjacent bipolar plate.
